(19) United States
(12) Patent Application Publication
(10) Pub. No.: US 2009/0326759 A1
(43) Pub. Date: Dec. 31, 2009

(54) ENHANCEMENT OF THE FUNCTIONALITY OF SERIES SOFTWARE IN A CONTROL UNIT

(76) Inventors: Daniel Hensel, Niederfischbach (DE); Klaus Schneider, Ludwigsburg (DE)

Correspondence Address: KENYON & KENYON LLP, ONE BROADWAY, NEW YORK, NY, 10004, US

(21) Appl. No.: 12/296,684

(22) PCT Filed: Mar. 15, 2007
(86) PCT No.: PCT/EP07/52439

§ 371 Date: Sep. 1, 2009

(51) Int. Cl. G06F 19/00

(52) U.S. Cl. 701/33

(57) ABSTRACT

A method for enhancing the functionality of series software of a control unit, in particular for a motor vehicle, having the steps of providing a control unit having an interface to which an external hardware device may be connected, having a non-volatile series software memory area in which the series software is stored, and having a volatile upload memory area, connecting an external hardware device, in which upload software is stored, to the interface loading the upload software from the external hardware device into the volatile upload memory area of the control unit, and executing the upload software in the upload memory area, the execution of the upload software enhancing the functionality of the series software by a diagnostic and/or test function.

### FIELD OF THE INVENTION

The present invention relates to a method for enhancing the functionality of series software in a control unit, in particular in a motor vehicle, and a corresponding control unit.

### BACKGROUND INFORMATION

Control units for a motor vehicle control the functions of the motor vehicle such as, for example, fuel injection, firing time, immobilizer, etc. The control unit has a microcontroller, which executes a predetermined control unit software, and a memory in which this control unit software is stored. The control unit controls function units (for example, the metering system for fuel injection into the engine and the like), which are connected to the control unit via a data bus, for example.

The control unit software has, in general, a diagnostic functionality with the aid of which errors occurring in the vehicle's operation may be diagnosed. To develop the diagnostic functionality, possible errors that may occur in the industrial production are collected during the development phase. Examples of such errors include errors that, according to experience, often occur and errors which are derived from a system analysis during development. In particular, errors may occur from the interaction of the numerous different vehicle components. The control unit software produces an appropriate diagnostic function for all of these errors.

After preparation of the control unit software, it is uploaded into a non-volatile memory (for example, a flash memory) in the control unit of the motor vehicle. Such prepared control unit software is also referred to hereinafter as “series software.”

However, practice has shown that it is almost impossible to take into account or anticipate all possible errors as early as during development and to produce a corresponding diagnostic function. If an error occurs during operation, for which no diagnostic function was produced during development, it is then impossible to analyze the cause of this error with the aid of the diagnostic functionality of the series software. This may result in time-consuming and costly troubleshooting in a service shop or the like and often in the exchange of non-defective components.

A common option for enhancing the diagnostic functionality of existing series software is to upload new, enhanced control software into the control unit. This, however, has the disadvantage that such a reprogramming is very complicated and furthermore, reprogramming in service is often not supported by the control unit itself.

German patent document DE 102 60 103 A1 proposes that, in addition to a regular, first non-volatile memory area, a second non-volatile memory area be provided in the control unit into which new software components (so-called patches) may be written. With the aid of branching from the first memory area, the new software components are executed in the second memory area instead of in the old software components in the first memory area. After executing the new software components, the procedure branches back from the second memory area into the first memory area.

Also in this case, the problem arises that uploading the patches is relatively complicated or may even not be supported. Furthermore, taking into account all diagnostic functions, possibly not developed by the time of delivery, results in bloating of the program code, for which extensive resources must then be accordingly provided.

### SUMMARY OF THE INVENTION

Therefore, a method is provided for enhancing the functionality of series software of a control unit, in particular for a motor vehicle, having the following steps:
providing a control unit having an interface to which an external hardware device may be connected, having a non-volatile series software memory area in which the series software is stored, and having a volatile upload memory area;
connecting an external hardware device, in which upload software is stored, to the interface;
loading the upload software from the external hardware device into the volatile upload memory area of the control unit, and
executing the upload software in the upload memory area, the execution of the upload software enhancing the functionality of the series software by a diagnostic and/or test function.

The control unit according to the present invention includes:
an interface to which an external hardware device may be connected;
a non-volatile series software memory area in which series software is stored;
a volatile upload memory area, which is connected to the interface and into which upload software is loaded from the external hardware device via the interface, the upload software enhancing the functionality of the series software by a diagnostic function and/or a test function; and
an arrangement for loading the upload software from the external hardware device into the volatile upload memory area of the control unit.

The external hardware device may be designed in particular as a diagnostic device. The arrangement for loading the upload software may be implemented in particular by an upload handler described below, which coordinates the loading of the upload software into the memory area provided therefor.

The exemplary embodiment and/or exemplary method of the present invention is based on the idea of achieving a need-oriented enhancement of the series software and in particular of the diagnostic and/or test functionality by loading enhancement software (upload software) into the RAM of the control unit. This results in the important advantage that the extension of the control unit by the diagnostic and/or test functionality may be achieved in a simple manner, i.e., in particular without complicated replacement of the series software.

Another advantage is that functions that are only used infrequently only need to be loaded as needed. For example, it is possible not to provide diagnostic functions, which are not called during the driving operation but only during diagnosis or maintenance, in the series software, but only in the upload software to be loaded as needed. Considerable resources are thus saved compared to the case where all diagnostic and test functions are provided in the series software.

Another advantage of the method according to the present invention is that it may be carried out without modifying the control unit.

It is advantageous if the upload software accesses only certain predefined parameters of the series software when the upload software is put to use. It is particularly advantageous if the behavior of the series software, in particular the run-time behavior of the series software, is not influenced by the execution of the upload software. This is, for example, impossible if the enhanced functionality is implemented off-board, i.e., the enhancement software runs on a diagnostic device, for example, and data are exchanged via an appropriate data link between the control unit and the diagnostic device. In this case, the times needed for data transmission distort the run-time behavior. In contrast, excellent real-time behavior is achieved using the method according to the present invention.

In a refinement of the method, the upload software is executed is only as long as the external hardware device is connected to the control unit. This ensures that the upload software is not erroneously activated.

In an advantageous refinement of the method, a further step is provided in which the upload software is authenticated by an authentication device. This ensures that the functionality for loading the upload software is not used without authorization (for example, for tuning the vehicle).

It is advantageous that when loaded from the external hardware device into the volatile upload memory area of the control unit, the upload software replaces a dummy upload software whose run-time behavior is identical to the run-time behavior of the upload software. This ensures that the run-time behavior of the control unit software is independent of whether or not the upload software is installed.

In an advantageous refinement of the method, a further step is provided in which the upload software is deleted after the upload software is executed and/or the upload software replaces a dummy upload software whose run-time behavior is identical to the run-time behavior of the upload software. This is a further measure to ensure that the upload software cannot be erroneously activated and the run-time behavior of the control unit software is independent of whether or not the upload software is installed.

In an advantageous refinement of the control unit, an authentication device is furthermore provided, which authenticates the upload software when it is loaded from the external hardware device into the upload memory area. This ensures that the functionality for loading the upload software is not used without authorization (for example, for tuning the vehicle).

In an advantageous refinement of the control unit, a dummy upload software is stored in the upload memory area, whose run-time behavior corresponds to the run-time behavior of the upload software, and which is replaced when the upload software is loaded from the external hardware device into the volatile upload memory area of the control unit. This ensures that the run-time behavior of the control unit software is independent of whether or not the upload software is installed.

The exemplary embodiment and/or exemplary method of the present invention is elucidated below in greater detail with reference to the exemplary embodiments illustrated in the figures of the drawings.

### BRIEF DESCRIPTION OF THE DRAWINGS

FIG. 1 shows a block diagram of a control unit according to a specific embodiment of the present invention, to which a diagnostic device is connected.

FIG. 2 shows a schematic diagram which illustrates the data flow and information flow in a method according to the present invention.

FIG. 3 shows a flow chart of a specific embodiment of a method according to the present invention.

### DETAILED DESCRIPTION

In all figures of the drawings, identical elements or elements having the same function are provided with the same reference numerals, unless indicated otherwise.

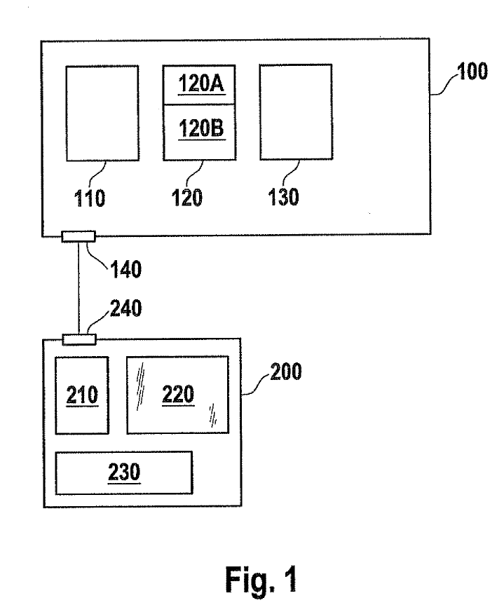

FIG. 1 is a block diagram of a control unit 100 according to the present invention, to which a diagnostic device 200 is connected. In the present example, control unit 100 is provided in a motor vehicle (not depicted in detail).

Control unit 100 includes a non-volatile memory 110, a volatile memory 120, a microprocessor 130 and an interface 140. Non-volatile memory 110 may be designed as a flash memory in particular. Factory-developed series software which controls the functional units of the motor vehicle is stored in this flash memory 110. The series software is loaded into microprocessor 130 and executed in a known manner.

Volatile memory 120 is a RAM which has a first memory area 120A and a second memory area 120B. First memory area 120A is used, for example, by the series software for saving function values or parameters. In second memory area 120B (hereinafter also referred to as “upload memory area”) upload software may be stored which enhances the functionality of the series software.

Flash memory 110 and RAM 120 are connected to interface 140, which may be designed as a CAN interface, for example. This interface 140 may be connected to a development tool from which the series software may be uploaded into flash memory 110. After control unit 100 is installed in the vehicle, interface 140 is connected to a diagnostic box (not depicted in detail) to which a diagnostic device 200 may be connected. This results in the system schematically depicted in FIG. 1.

As depicted in FIG. 1, diagnostic device 200 includes a memory 210, a display 220, an input device 230 (for example, a keyboard), and an interface 240, and may be designed as a PC, a laptop or the like. Upload software developed in a special development environment is stored in memory 210. This upload software may include, for example, diagnostic functions or test functions which are not contained in the series software already installed in control unit 100. In particular, such diagnostic functions or test functions may also have been developed after delivery of the series software. The upload software may be loaded into upload memory area 120B via interfaces 240 and 140 with the aid of an instruction entered into input device 230. The series software stored in flash memory 110 is thus enhanced. The measured values, analysis results or the like ascertained by the upload software (or also by the series software) within an error diagnosis may be displayed on display 220. In an alternative specific embodiment it is, however, also possible to separate diagnostic device 200 from control unit 100 after uploading the upload software and to save, in a suitable memory (for example, in a drive recorder), the measured values or the like ascertained during an error diagnosis and to read and analyze them at a later point in time.

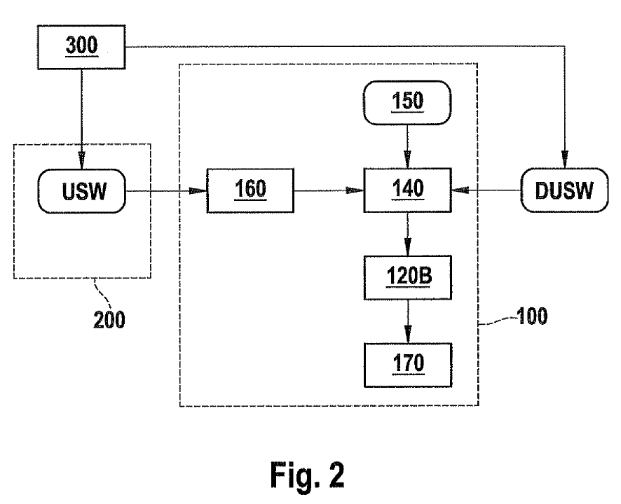

FIG. 2 shows a schematic diagram which illustrates the data flow and information flow in an exemplary method for enhancing the functionality of the series software of the above-described control unit 100. Upload software USW is created in a special development environment 300. This development environment ensures that upload software USW does not interfere with the normal run of the series software and thus does not cause the running behavior of the series software to be corrupted. In particular, development environment 300 ensures that upload software USW does not facilitate any unauthorized access to the series software. This may be achieved, for example, by allowing upload software USW only read access to certain parameters (for example, variables and functions) of the series software and write access to certain areas of a RAM area.

After transfer from development environment 300 to diagnostic tester 200 and connecting diagnostic tester 200 to control unit 100, upload software USW may be loaded into upload memory 120B via run-time environment 140 of control unit 100. Loading of upload software USW is coordinated by a so-called upload handler, which ensures that upload software USW is loaded into the memory area provided therefor. The upload handler may be designed in particular to be part of operating system 150 of control unit 100 and it is a mechanism which is made available for achieving a temporary enhancement of the series software by the upload software.

While upload software USW is loaded into upload memory 120B, authentication device 160 authenticates upload software USW. The function of this authentication device 160 may also be assumed by upload handlers. By manipulating the software executed by control unit 100 it is possible, for example, to enhance the performance of the motor vehicle (so-called tuning). This, however, results in increased safety risks in road traffic and is therefore undesirable by the manufacturer, also with regard to clear liability issues. Authentication of the upload software using authentication device 160 should therefore ensure that the upload functionality does not result in unauthorized modification (i.e., tuning), by third parties, of the software executed by control unit 100. A simple protection against such manipulations may be achieved with the use of passwords. For this purpose, a password is saved in flash memory 110 and writing the upload software into upload memory 120B is permitted by authentication device 160 only when the correct password is presented by diagnostic device 200 or by the upload software. Improved protection may be achieved by the use of certificates and an asymmetric encryption system. The software to be transferred is signed using the private key of the certifying body, i.e., here by the manufacturer of the upload software, and may be checked by the control unit using the corresponding public key.

After upload software USW is loaded, it is executed on control unit 100. Upload software USW may access only predetermined parameters or interfaces 170. For example, upload software USW may have only read access to the series software and may have write access only to a certain area of RAM 120. In addition to such access rights, boundary conditions regarding the system resources (for example, transfer bandwidth) are also taken into account. This ensures that the series software is not influenced by the upload software without authorization.

The execution of the upload software is controlled by the upload handler. For this purpose, the upload handler, like any other control unit function, is entered into the operating system and is therefore called by the operating system. The operating system may call the upload handler under interrupt control to achieve rapid response, but it usually does so with the aid of an appropriate scheduling of the operating system. When the upload software is loaded, the upload handler sets an internal status which indicates that upload software is available and where it is located. When the upload handler is then called by the operating system, the upload handler checks this status and, as the case might be, executes the upload software. This may be accomplished by the upload handler causing the program sequence to branch to the upload software or an appropriate portion of the upload software.

Prior to loading upload software USW into memory area 120B, a dummy upload software DUSW (for example, made of noop code) is provided there. It has the same run-time properties as upload software USW to be loaded later. During regular driving operation, dummy upload software DUSW is called and executed by the operating system or by the upload handler. The dummy upload software thus ensures that the run-time behavior of the series software is the same, regardless of whether or not upload software has been loaded. The dummy upload software thus also determines the specification of upload software to be developed later. In other words, the dummy upload software keeps a certain run time in the execution of the series software free. The upload software is then developed, making sure that this run time is not exceeded. It is also possible for the dummy upload software to keep a plurality of time blocks of different lengths, each of which corresponds to a certain memory area in upload memory 120B, free. In this case, the upload software is stored by the upload handler in a memory area corresponding to its run time.

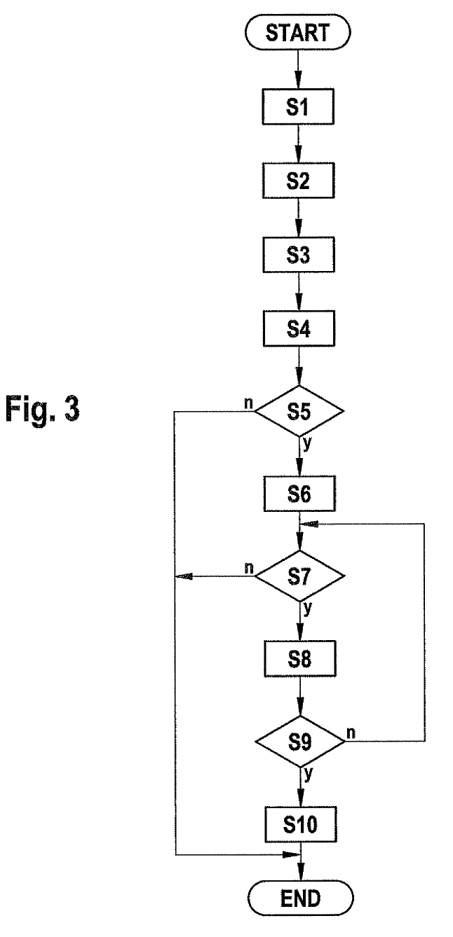

FIG. 3 shows a flow chart of a specific embodiment of a method according to the present invention.

In step S1 the above-described control unit 100 and the above-described diagnostic tester 200 are provided. Typically, control unit 100 is installed in a vehicle which has already traveled a certain mileage. Errors may occur in the vehicle for which no diagnosis functionality has been provided in the series software of control unit 100. Such a functionality is provided using the method described herein, which makes accurate analysis of such errors possible. It is furthermore possible to implement diagnosis functions which cannot or should not be performed in normal driving operation. One example of such a function is a compression test for testing the compression of the cylinders. In such a test, injection is turned off and conclusions are drawn regarding the cylinder compression via a sensor, so that such a test is performed only in a workshop diagnosis. The use of the present method for such functions which are not performed in regular driving operation makes it possible to save the corresponding memory space in the series software. The method may thus be performed during routine servicing or due to obvious or suspected errors in the vehicle. The method is suitable in particular for being carried out in authorized workshops and facilitates the analysis performed there.

In step S2 diagnosis tester 200, in which upload software USW is stored, is connected to control unit 100 by connecting the particular interfaces. For example, diagnosis tester 200 may be connected to the diagnostic box provided for this purpose in the vehicle.

In step S3, upload software USW is loaded by diagnostic tester 200 into upload memory area 120B of control unit 100. For this purpose, upload software USW is copied by diagnosis tester 200 into upload memory area 120B and saved there. This loading process is controlled by the above-described upload handler.

In step S4, upload software USW is authenticated (i.e., its origin is verified). This may take place, for example, with the aid of certificates as described above, for example, via decoding, with the aid of the corresponding public key previously stored in memory 110, of the upload software encrypted (or signed) using a private key. Details regarding suitable authentication algorithms may be found, for example, in Bruce Schneier, “Applied Cryptography,” John Wiley & Sons, 1996.

In step S5 a check is made of whether the authentication in step S4 was successful. If the authentication was successful, the method jumps to step S6; otherwise the method is aborted.

In step S6, the upload software is activated via an appropriate input in keyboard 230 of diagnostic device 200.

In step S7 a check is made of whether diagnostic device 200 is still connected to control unit 100. If this is the case, the method jumps to step S8; otherwise the method is aborted. This ensures that the upload software is not executed during regular driving operation, for example, due to a hardware error, but may only be executed in diagnostic operation.

In step S8 the upload software is executed in upload memory area 120B (or a portion, for example, a program block thereof). The upload software enhances the functionality of the series software by a diagnostic function which may be called, for example, from diagnostic device 200 via an appropriate input on keyboard 230.

In step S9 an abort condition is checked, i.e., for example, whether an input has been made on diagnostic device 200 for terminating the upload software. If this is the case, the method jumps to step S10; otherwise the method jumps back to step S7.

In step S10 upload software USW is deleted from upload memory area 120B and replaced by dummy upload software DUSW.

Using the above-described method, the diagnostic and/or test functionality of control unit 100 may be enhanced in a simple manner, i.e., in particular without complicated replacement of the series software. Another advantage of the above-described method is that it may be carried out without modifying the control unit.

Although the exemplary embodiment and/or exemplary method of the present invention was described above with reference to an exemplary embodiment, it is not limited thereto, but may be modified in many ways.

For example, the external hardware device is designed as a diagnostic tester in the above-described example. It may, however, also be designed as a drive recorder provided with the appropriate functionality.

Furthermore, in the above-described example, authentication is not performed until the encrypted upload software is loaded into upload memory 120B; it is, however, possible to initially perform authentication of diagnostic device 200 using a handshake (for example, with the aid of a password or the like) and only then to load the upload software.

1-10. (canceled)

11. A method for enhancing a functionality of series software of a control unit for a motor vehicle, the method comprising:
providing the control unit having an interface to which an external hardware device is connectable, having a non-volatile series software memory area in which the series software is stored, and having a volatile upload memory area;
connecting an external hardware device in which upload software is stored at the interface;
loading the upload software from the external hardware device into the volatile upload memory area of the control unit; and
executing the upload software in the upload memory area, the execution of the upload software enhancing the functionality of the series software by at least one of a diagnostic function and a test function.

12. The method of claim 11, wherein the upload software accesses only certain predefined parameters of the series software when the upload software is executed.

13. The method of claim 11, wherein the run-time behavior of the series software is not influenced by the execution of the upload software.

14. The method of claim 11, wherein the upload software is executed only as long as the external hardware device is connected to the control unit.

15. The method of claim 11, further comprising:
authenticating the upload software by an authentication device.

16. The method of claim 1, wherein, when loaded from the external hardware device into the volatile upload memory area of the control unit, the upload software replaces a dummy upload software whose run-time behavior is identical to the run-time behavior of the upload software.

17. The method of claim 11, further comprising:
after the upload software is executed, at least one of deleting the upload software and using the upload software to replace a dummy upload software whose run-time behavior is identical to the run-time behavior of the upload software.

18. A control unit, comprising:
an interface to which an external hardware device is connectable;
a non-volatile series software memory area in which series software is stored;
a volatile upload memory area, which is connected to the interface and into which upload software is loaded from the external hardware device via the interface, the upload software enhancing the functionality of the series software by at least one of a diagnostic function and a test function; and
a loading arrangement to load the upload software from the external hardware device into the volatile upload memory area of the control unit.

19. The control unit of claim 18, further comprising:
an authentication device to authenticate the upload software when it is loaded from the external hardware device into the upload memory area.

20. The control unit of claim 18, wherein a dummy upload software is stored in the upload memory area whose run-time behavior is identical to the run-time behavior of the upload software and which is replaced when the upload software is loaded from the external hardware device into the volatile upload memory area of the control unit.
